(19) United States
(12) Patent Application Publication
(10) Pub. No.: US 2007/0055813 A1
(43) Pub. Date: Mar. 8, 2007

(54) Accessing external memory from an integrated circuit

(75) Inventors: Graeme Leslie Ingram, Royston (GB); Spencer John Saunders, Biggleswade (GB); David John Gwilt, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/500,392

(22) Filed: Aug. 8, 2006

(30) Foreign Application Priority Data
Sep. 8, 2005 (GB) 0518354.6

(51) Int. Cl. G06F 12/00; G06F 13/00

(52) U.S. Cl. 711/100; 710/35

(57) ABSTRACT

An integrated circuit and method of operating the integrated circuit to access external memory are provided. The integrated circuit comprises interconnect logic for coupling master logic units and slave logic units to enable transactions to be performed, each transaction comprising an address transfer from a master logic unit to a slave logic unit and one or more data transfers between that master logic unit and that slave logic unit. At least one master logic unit is operable when seeking to access data from an external memory to initiate a transaction by issuing the address transfer via the interconnect logic, the transaction having format information associated therewith used to format the one or more data transfers of the transaction for transfer over the interconnect logic. A memory controller acts as a slave logic unit for the transaction, and is coupled to the external memory via an external bus. The memory controller processes the transaction by issuing one or more commands to the external memory over the external bus to cause one or more external data transfers to take place between the memory controller and the external memory. In accordance with the present invention, for each command the memory controller can select an external format for the one or more external data transfers having regard to at least one predetermined constraint of the external memory and the format information of the transaction. This approach allows a particularly efficient utilisation of the external bus connecting the memory controller with the external memory.

### BACKGROUND OF THE INVENTION

1. Field of the Invention

The present invention relates to techniques for accessing external memory from an integrated circuit.

2. Description of the Prior Art

Within an integrated circuit having a plurality of master logic units and slave logic units, it is known to provide interconnect logic for coupling the master logic units and the slave logic units to enable transactions to be performed. Each transaction consists of an address transfer from a master logic unit to a slave logic unit, and one or more data transfers between the master logic unit and that slave logic unit. For a write transaction these data transfers will pass from the master logic unit to the slave logic unit, whilst for a read transaction these data transfers will pass from the slave logic unit to the master logic unit. The interconnect logic will take the form of a bus infrastructure providing a plurality of connection paths for coupling the various master logic units and slave logic units. One example of such an integrated circuit is a so-called System-on-Chip (SoC).

Whilst the integrated circuit may include some internal memory for storing data accessible by the master logic units of the integrated circuit, such memory is relatively expensive, and accordingly it is often the case that the integrated circuit will be coupled with some external memory for storing data for access by the master logic units of the integrated circuit. In such instances, a memory controller is typically provided within the integrated circuit for interfacing with the external memory via an external bus. The external memory may be static memory, for example static RAM (Random Access Memory), NOR Flash memory, etc, or alternatively may take the form of dynamic memory, for example SDRAM. Dynamic memory uses less transistors to store each data value, and accordingly generally offers higher density and higher access speeds when compared with static memory. However, dynamic memory typically requires refreshing periodically in order to retain the data values stored therein, due to leakage current occurring within the dynamic memory.

The transactions occurring within the integrated circuit can take a variety of forms, with the exact form of a transaction being dependent on the master logic unit. As an example, a processor core may specify transactions in the form of wrapped bursts of multiple data transfers, each data transfer often being referred to as a “beat”. A processor core often uses wrapped bursts since this enables the most time critical data value to be accessed first. As another example, a graphics engine may issue transactions specifying a single beat. As yet another example, a display controller may issue transactions specifying incrementing burst accesses, since such incrementing burst accesses provide better bandwidth performance than wrapped burst accesses.

Currently external memory devices, whether static or dynamic, are programmed to operate in a fixed mode of operation, that is with a fixed burst length and fixed burst type. To change this mode of operation, a processor is required to update the external memory device and the memory controller, and this is a relatively slow process. In particular, a memory device and associated memory controller cannot be programmed in between accesses from different master logic units. As a result, the memory device and controller are typically programmed with a compromise fixed burst length and burst type with the aim of achieving reasonable overall performance in the system.

In a typical system, it will generally be the case that the bottleneck in processing transactions occurs over the external bus connection between the memory controller and the external memory. As systems increase in complexity, the bandwidth requirements for this external bus connection are increasing, and this has a tendency to make this bottleneck become more marked. One way to seek to alleviate this processing bottleneck is to increase the operating speed of the interface between the memory controller and the external memory, but this increases the power consumption of the system, and leads to a more complex design.

Accordingly, it would be desirable to provide a technique which allowed more efficient access to the external memory by the integrated circuit.

### SUMMARY OF THE INVENTION

Viewed from a first aspect, the present invention provides an integrated circuit comprising: interconnect logic operable to couple master logic units and slave logic units to enable transactions to be performed, each transaction comprising an address transfer from a master logic unit to a slave logic unit and one or more data transfers between that master logic unit and that slave logic unit; at least one master logic unit operable when seeking to access data from an external memory to initiate a transaction by issuing the address transfer via the interconnect logic, the transaction having format information associated therewith used to format the one or more data transfers of the transaction for transfer over the interconnect logic; a memory controller operable to act as a slave logic unit for the transaction, the memory controller being coupled to the external memory via an external bus and being operable to process the transaction by issuing one or more commands to the external memory over the external bus to cause one or more external data transfers to take place between the memory controller and the external memory; for each command the memory controller being operable to select an external format for the one or more external data transfers having regard to at least one predetermined constraint of the external memory and the format information of the transaction.

In accordance with the present invention, for each command the memory controller is able to select an external format for data transfers to take place via the external bus, and is arranged when making such a selection to take into account at least one predetermined constraint of the external memory and the format information of the transaction. By taking into account the format information of the transaction used to format the one or more data transfers over the interconnect logic of the integrated circuit, the memory controller can aim to select an external format which will enable the external data transfers required when processing the transaction to occur in an efficient manner, taking into account at least one predetermined constraint of the external memory. In some instances, this will mean that the external format can mirror the format used for the data transfers occurring internal to the integrated circuit over the interconnect logic.

To enable the benefits of the present invention to be realized, the external memory needs to support the use of varying external formats, but once such support is provided, the technique of embodiments of the present invention enables a significant improvement in the efficiency of usage of the external bus.

The format information of the transaction can take a variety of forms. However, in one embodiment, the format information comprises at least one of a burst length identifying the number of data transfers to take place over the interconnect logic and a burst type identifying how the address of the data accessed is altered between each data transfer.

In one embodiment, the format information further comprises an interconnect data size indicating the amount of data in each data transfer over the interconnect logic. Based on this information, it is then possible for the memory controller to determine a transaction size identifying the total amount of data to be transferred by the transaction.

The format information of the transaction can be varied on a transaction-by-transaction basis, although it may be the case that a particular master logic unit may always issue a transaction having predetermined format information, for example a particular master logic unit may issue a transaction that always specifies a single data transfer, i.e. has a burst length of one. In one embodiment, the format information is included in the address transfer.

In addition, in one embodiment, the external format selected by the memory controller can be specified within the command issued to the external memory over the external bus. This can be achieved by simply adding extra bits to the command to specify the external format, or alternatively can instead be achieved by passing the command to the external memory in more than one cycle, thereby avoiding an increase in the pin count of the interface via which the command is issued.

The at least one predetermined constraint of the external memory can take a variety of forms. However, in one embodiment the predetermined constraint comprises a maximum external memory burst length. This hence identifies the maximum number of data transfers that can result from a particular command issued to the external memory over the external bus. This maximum burst length is typically imposed by the memory as a compromise of performance versus gate area. However, in some embodiments, the maximum burst length constraint of the external memory may be imposed by the memory controller. For example some static memories have a continuous burst length, in which case the memory controller will impose a maximum burst length constraint on the external memory.

In one embodiment, the at least one predetermined constraint further comprises an external bus data size indicating the amount of data in each data transfer over the external bus. Based on this information, the memory controller can determine a maximum external memory access size identifying the maximum amount of data that can be transferred over the external bus in response to a data transfer command issued by the memory controller to the external memory.

There are a number of ways in which the external format can be selected having regard to the at least one predetermined constraint of the external memory and the format information of the transaction. In one embodiment, the memory controller is operable to determine from the format information of the transaction the transaction size, and to determine from the at least one predetermined constraint the maximum external memory access size, and if the transaction size is less than or equal to the maximum external memory size, the memory controller is operable to issue a data transfer command and to select as the external format specified by the data transfer command a format which employs the least number of external data transfers to access the data specified by the transaction. Assuming the interconnect data size and the external bus data size are the same, the number of external data transfers will typically match the burst length for the transaction identifying the number of data transfers occurring over the interconnect logic. However, if the interconnect data size and external bus data size differ, then the number of external data transfers specified by the external format will differ to the number of data transfers over the interconnect logic specified by the format information of the transaction. Considering one particular example, if the external bus data size is half that of the interconnect data size, then the memory controller will ideally select as the external format a format which employs twice the number of external data transfers than the number of data transfers employed over the interconnect logic.

In one embodiment, if the transaction size is greater than the maximum external memory size, the memory controller is operable to issue a data transfer command and to select as the external format specified by the data transfer command a format which employs a number of external data transfers determined by the maximum external memory burst length, the memory controller being operable to subsequently issue one or more further data transfer commands to cause the remainder of the data specified by the transaction to be accessed. Hence, in such embodiments, the maximum external memory burst length can be utilised to allow as much as possible of the data associated with the transaction to be accessed via the first data transfer command, and then one or more further data transfer commands can be used to cause the remainder of the data to be accessed, thereby making most efficient use of the external bus resources.

In one embodiment, if the transaction size is greater than the maximum external memory size, and the format information of the transaction specifies a wrap burst type, the memory controller is operable to issue a data transfer command and to select as the external format specified by the data transfer command a format which employs an increment burst type and a number of external data transfers less than or equal to the maximum external memory burst length, the memory controller being operable to subsequently issue one or more further data transfer commands to cause the remainder of the data specified by the transaction to be accessed.

It situations where the transaction size is greater than the maximum external memory size, and the transaction specifies a wrap burst type, it will not be possible to replicate the wrapped burst on the external memory bus. Instead, the first data transfer command issued by the memory controller will employ an increment burst type, and will seek to access as much as possible of the data specified by the transaction whilst not exceeding the maximum external memory burst length. Hence, by way of example, if the transaction specifies a wrap burst having a burst length of eight, with data value 6 of the data values 0 to 7 being accessed first, and the maximum external memory burst length is four, then the first data transfer command will specify an increment burst type, and a burst length of two, in order to enable data values 6 and 7 to be accessed. The remainder of the data specified by the transaction will be accessed by two subsequent data transfer commands.

The external memory can take a variety of forms. In one embodiment, the external memory is dynamic memory consisting of a number of banks of memory. More particularly, in one embodiment, the dynamic memory consists of a plurality of chips, with each chip having a plurality of banks. In an alternative embodiment, the external memory is static memory.

Viewed from a second aspect, the present invention provides a method of operating an integrated circuit to access external memory, the integrated circuit having interconnect logic operable to couple master logic units and slave logic units to enable transactions to be performed, each transaction comprising an address transfer from a master logic unit to a slave logic unit and one or more data transfers between that master logic unit and that slave logic unit, the method comprising the steps of: when a master logic unit wishes to access data from the external memory, initiating a transaction by issuing the address transfer via the interconnect logic, the transaction having format information associated therewith used to format the one or more data transfers of the transaction for transfer over the interconnect logic; causing a memory controller to act as a slave logic unit for the transaction, the memory controller being coupled to the external memory via an external bus and processing the transaction by issuing one or more commands to the external memory over the external bus to cause one or more external data transfers to take place between the memory controller and the external memory; for each command the memory controller selecting an external format for the one or more external data transfers having regard to at least one predetermined constraint of the external memory and the format information of the transaction.

### DESCRIPTION OF THE DRAWINGS

The present invention will be described further, by way of example only, with reference to embodiments thereof as illustrated in the accompanying drawings, in which:

FIG. 1 is a block diagram of a system in accordance with one embodiment of the present invention;

FIG. 2 is a block diagram illustrating in more detail the memory controller of FIG. 1;

FIGS. 3A to 3C illustrate the format of the address transfer and resultant command issued by the memory controller, at various points within the memory controller logic illustrated in FIG. 2;

FIG. 4 is a flow diagram illustrating the process performed by the arbitration and format logic of FIG. 2; and

FIGS. 5 to 7 are timing diagrams providing examples of particular transactions, and contrasting how external memory would be accessed for such transactions in accordance with a known technique and in accordance with the technique of one embodiment of the present invention.

### DESCRIPTION OF EMBODIMENTS

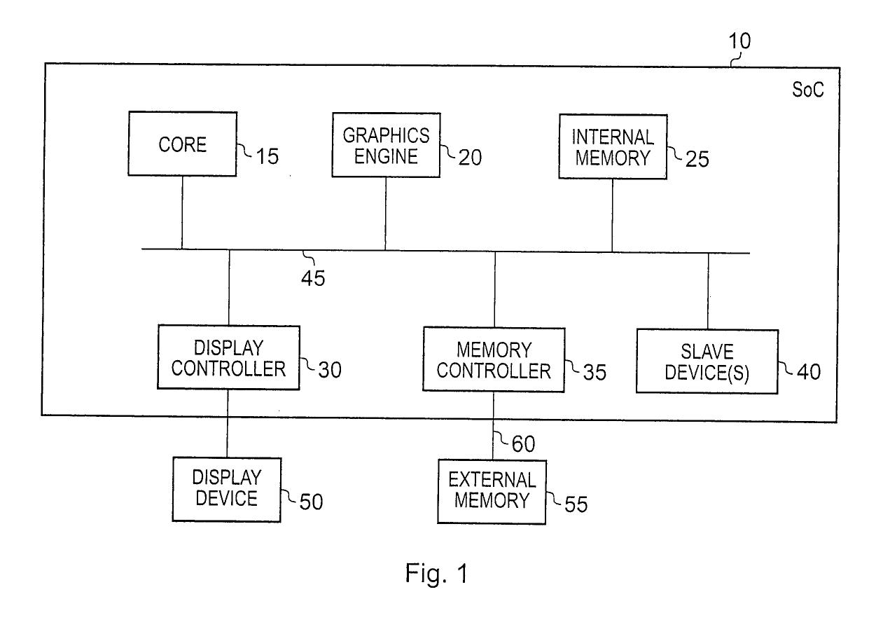

FIG. 1 is a block diagram of a system in accordance with one embodiment of the present invention. In particular, an integrated circuit in the form of a SoC 10 is shown, the SoC 10 including a number of master devices and a number of slave devices connected via interconnect logic 45. In particular, three master devices are illustrated, namely a processor core 15, a graphics engine 20 and a display controller 30. Similarly, three slave devices are shown, namely an internal memory 25, a memory controller 35, and one or more other slave devices 40 (which could for example be a smart card interface (SCI), a Universal Asynchronous Receiver/Transmitter (UART) device, etc).

The interconnect logic 45 will provide a plurality of connection paths for coupling the various master logic units and slave logic units. The way in which the various transfers of a transaction are routed via those connection paths will be dependent on the bus protocol employed within the interconnect logic. One known type of bus protocol is the non-split transaction protocol, such as is employed within a system having an AHB bus designed in accordance with the AHB bus protocol developed by ARM Limited, Cambridge, United Kingdom. In accordance with such a non-split transaction protocol, there is a fixed timing relationship between the address transfer of a transaction and the subsequent one or more data transfers of that transaction.

As interconnect logic increases in complexity, due to the need to support the interconnection of a larger number of master and slave logic units, then another type of bus protocol has been developed known as a split transaction protocol. In accordance with such a split transaction protocol, the plurality of connection paths within the interconnect logic provide at least one address channel for carrying address transfers and at least one data channel for carrying data transfers. An example of such a split transaction protocol is the AXI (Advanced eXtensible Interface) protocol developed by ARM Limited, Cambridge, United Kingdom. The AXI protocol provides a number of channels over which information and data can be transferred, these channels comprising a read address channel for carrying address transfers of read transactions, a write address channel for carrying address transfers of write transactions, a write data channel for carrying data transfers of write transactions, a read data channel for carrying data transfers of read transactions, and a write response channel for returning transaction status information to the master logic unit at the end of a write transaction, such transaction status information indicating for example whether the transaction completed successfully, or whether an error occurred, etc.

Whilst for the purposes of the present invention, the interconnect logic 45 can take a variety of forms, and hence for example may employ an AHB bus infrastructure or an AXI bus infrastructure as discussed above, it will be assumed for the purposes of the following description that the interconnect logic 45 has an AXI bus infrastructure.

As shown in FIG. 1, the display controller 30 is connected to an external display device 50 for displaying information to a user. In addition the memory controller 35 is connected to an external memory 55 via an external bus 60. The external bus 60 can take a variety of forms, but in one embodiment is a simple point-to-point bus connecting the memory controller 35 to the external memory 55, and can be considered to provide a control channel for the passing of commands from the memory controller 35 to the external memory 55, along with a bi-directional data channel for the communication of data between the memory controller 35 and the external memory 55.

When performing data processing operations, the processor core 15 will typically need to access data stored in memory. This data may be cached locally to the core, but in the event of a cache miss it will be necessary for the core to access the data directly from memory. This data may reside in the internal memory 25 or in the external memory 55. However, whilst the internal memory 25 provides relatively quick access to the data, it is typically relatively expensive when compared with external memory 55, and hence a significant amount of the data required will be stored in the external memory. When seeking to access data from the external memory, the processor core 15 will initiate a transaction by issuing an address transfer via the interconnect logic 45 to the memory controller 35, and this will cause the memory controller 35 to issue one or more commands to the external memory 55 over the external bus 60 to cause the required data to be accessed in the external memory.

The graphics engine 20 will be arranged to perform certain specific graphics operations on data stored within memory, and in doing so may need to initiate transactions to cause data to be retrieved from the external memory 55 via the memory controller 35. Typically, the processed data produced by the graphics engine will then be written back to memory.

The display controller 30 will retrieve data from memory for output to the display device 50, and accordingly will issue transactions to memory to retrieve the required data to be displayed. Again, this data may reside at least partly in external memory 55, and accordingly transactions will need to be initiated by the display controller 30 to cause the memory controller 35 to retrieve the required data.

The form of the transactions issued by the various master logic units may vary on a transaction-by-transaction basis. However, the processor core may generally use transactions specifying wrapped bursts so as to enable the critical data value to be provided first. In contrast, the display controller may tend to use incremented bursts when seeking to access data, since this generally provides better bandwidth performance when compared with wrapped bursts. Meanwhile, the graphics engine may generally be seeking to access the memory using transactions specifying a single beat, i.e. a single data transfer.

In a typical known system, the external memory 55 will be programmed to operate in a fixed mode of operation, that is with a fixed burst length and a fixed burst type. Whilst this mode of operation can be changed by using the processor to program the external memory device from the memory controller, this is not a quick process, and accordingly the memory controller 35 and the external memory 55 would typically be programmed to use a compromise fixed burst length and type when processing all transactions. However, as will be discussed in more detail later, embodiments of the present invention enable the memory controller to select for each data transfer command issued over the external bus an external format that can take into account the format of the transaction taking place between the master device and the memory controller 35 over the interconnect logic 45 within the integrated circuit 10, which provides a more efficient utilisation of the external bus 60.

The external memory 55 can take the form of either dynamic memory or static memory. Dynamic memory typically consists of a number of chips, with each chip having a plurality of banks. A dynamic device is typically accessed by issuing an activate command to open a row within a particular bank, after which the required data is then accessed within that row with an address passed to the memory in a single cycle qualified with a strobe signal “column address strobe” (CAS). Typically only one row in each bank can be open at a time, and accordingly prior to opening another row it would be necessary to close the current row, this being achieved through the use of a precharge command. In contrast to dynamic devices, static memory devices do not need activate and precharge commands to open and close rows, and instead are typically accessed by issuing a single value of address for a particular burst access, or sometimes a single address value per beat of a burst.

For either type of memory device, it will be appreciated that the issuance of a data transfer command from the memory controller 35 to the external memory 55 (in the instance of dynamic memory this data transfer command passing an address qualified with a CAS signal, whilst for a static memory this data transfer command issuing the address without any associated strobe signal) causes one or more external data transfers to take place over the external bus to transfer the required data from the memory controller 35 to the external memory 55 (in the event of a write operation) or from the external memory 55 to the memory controller 35 (in the event of a read operation). The techniques of the embodiments of the present invention are equally applicable to both dynamic memory and static memory. However, for the purpose of the embodiment described with reference to the following drawings, it will be assumed that the external memory 55 is a dynamic memory.

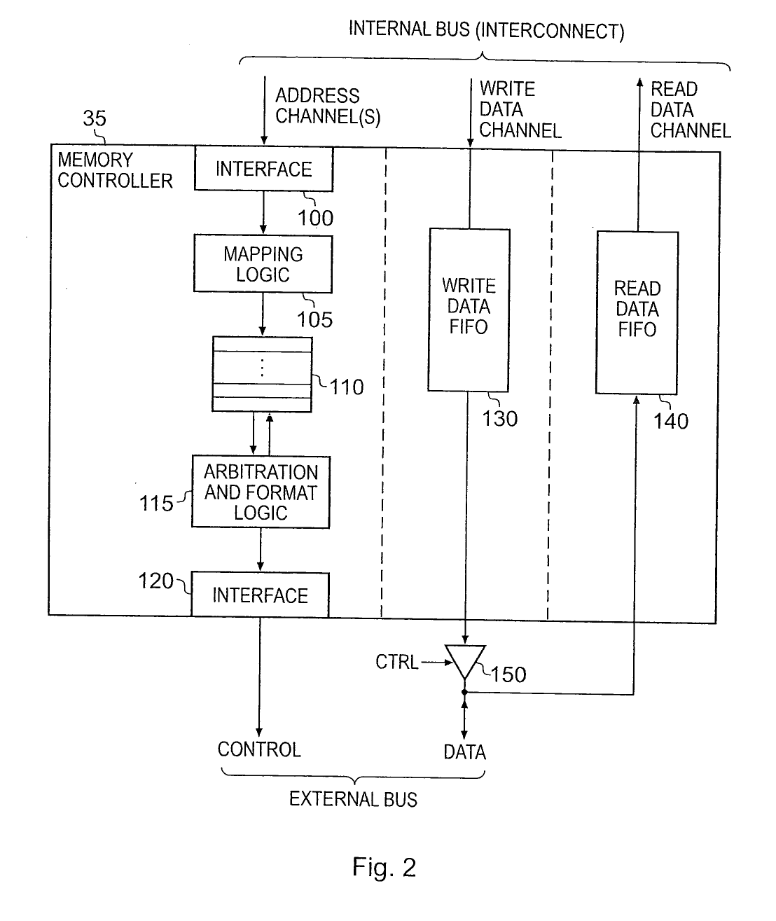

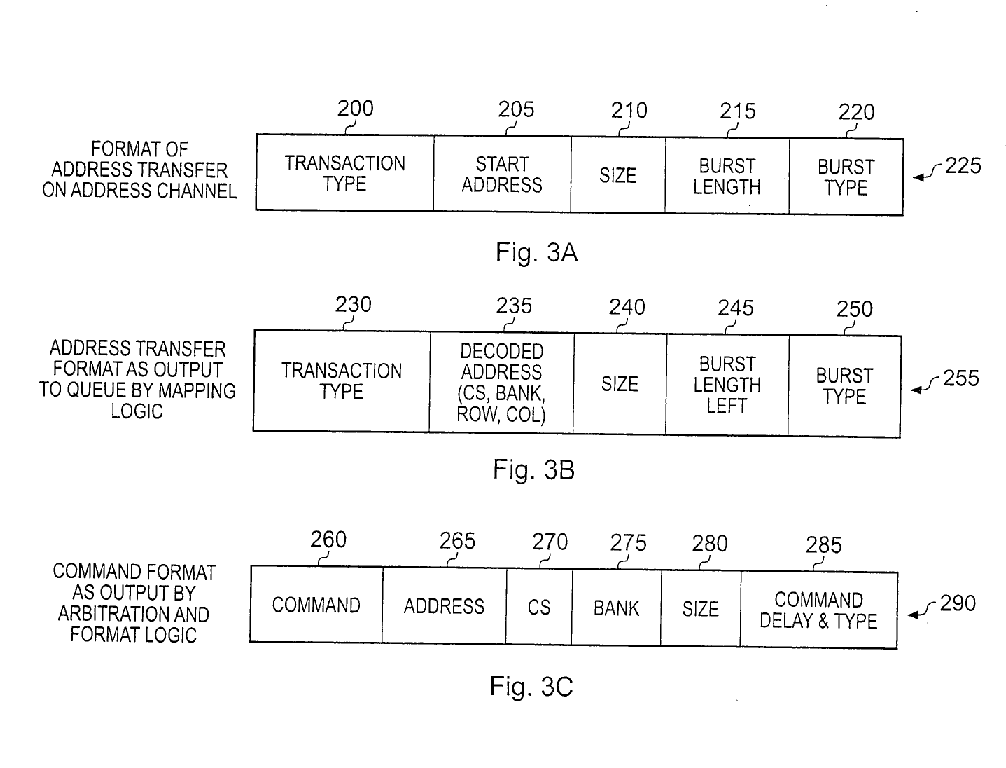

FIG. 2 is a block diagram illustrating in more detail elements provided within the memory controller 35 of FIG. 1 in accordance with one embodiment of the present invention. As discussed earlier, the interconnect logic 45 of one embodiment of the present invention will provide separate address, write data and read data channels and the memory controller 35 can be considered to provide three logical paths corresponding to those different channels, as indicated by the dotted lines in FIG. 2. Considering the logic provided in association with the write and read address channels of the interconnect logic 45, an interface 100 is provided for receiving each address transfer issued by a master logic unit over the interconnect logic 45 to the memory controller 35. The actual format of this address transfer can vary dependent on implementation, but an example of such an address transfer as received by the interface 100 is illustrated schematically in FIG. 3A.

This address transfer 225 will comprise a number of fields, and as shown in FIG. 3A may include a transaction type field 200 identifying the type of transaction, for example whether it is a read transaction or a write transaction, a start address field 205 identifying the address of a first data value to be accessed, a size field 210 identifying the amount of data to be included in each data transfer over the interconnect logic 45 (for example word, half word, byte, etc), a burst length field 215 identifying the number of beats, or data transfers, to form the transaction, and a burst type field 220 identifying the type of the burst, for example whether it is a wrap burst or an increment burst. As an example, if the burst length specified in the burst length field 215 is four, and the burst type is “wrap”, then the addresses will wrap around the least two significant bit positions. Hence, if the start address in the start address field 205 identifies a data value 1 then the four bursts will retrieve data values 1, 2, 3 and 0, respectively (after data value 3, the least significant bits of “11” being wrapped to the value “00” without incrementing any of the more significant bits of the address). In contrast, if for the same transfer the burst type had been specified as increment, then the data values 1, 2, 3, 4 would have been accessed.

This address transfer is then routed from the interface 100 to the mapping logic 105 where it is converted into the format illustrated schematically in FIG. 3B and then placed in a queue 110. As shown in FIG. 3B, the address transfer format 255 has a transaction type field 230, which in one embodiment may be unchanged with respect to the transaction type field 200 of the address transfer format 225 received over the address channel. Similarly, the address transfer format 255 contains a size field 240 and a burst type field 250, which in one embodiment may be considered unchanged with respect to the equivalent size field 210 and burst type field 220 of the original address transfer format 225. The address transfer format 255 also includes a burst length left field 245, which initially will contain the same information as was contained in the burst length field 215 of the original format 225, but may in due course be modified by the arbitration and format logic 115 to be discussed later. The burst length left field 245 may in one embodiment merely store the number of bursts, but in an alternative embodiment can actually store the number of bytes left to transfer (by in effect combining the burst length and size information). The main task undertaken by the mapping logic 105 is to map the start address to a particular row and column within a bank and chip of the dynamic memory, this resulting in the decoded address field 235 providing a chip select value, a bank indication, a row indication and a column indication.

The arbitration and format logic 115 is arranged to process the address transfers placed in the queue 110. However, rather than merely operating the queue 110 as a FIFO (first-in-first-out) buffer, the arbitration and format logic 115 will typically perform some arbitration with the aim of making most efficient use of the memory. In particular, as mentioned earlier, when accessing dynamic memory, it is necessary to open a particular row before you can then access any columns in that row. Given this, one form of arbitration that may be applied by the arbitration and format logic 115 is to determine whether there are any entries in the queue 110 that identify address transfers that will take place to the same row as that already opened within a particular bank, since it will generally be more efficient to process those transfers first before the row is closed and another row is opened. Additionally, it will be appreciated that any other suitable arbitration techniques may be employed, so as for example to give priority to transactions issued by particular master devices, etc. Regarding this latter point, typically each transfer has an ID associated therewith identifying the master device with which that transfer is associated, and this ID information can be used in the prioritization process.

Once a particular entry from the queue has been selected by the arbitration and format logic 115, then that logic will generate one or more commands for issuing to the interface 120, the format of such commands being illustrated schematically in FIG. 3C. As shown in FIG. 3C, the command format 290 will contain a command field 260 identifying the type of command, for example activate, precharge, data transfer (either read or write), etc. The address field 265 will then identify address information relevant to the command. For an activate command, this address information will typically identify a row to be opened, whilst for a precharge command this address information will be redundant, since the particular bank being accessed by the precharge command will know which row is open and accordingly can decide how to apply the precharge command. For a data transfer command, this address field 265 will contain the column identifier identifying the column to be accessed within the open row of the relevant bank. The chip select field 270 and the bank field 275 will then identify the particular chip and bank of the dynamic memory to be accessed. The size field 280 will then identify the amount of data to be transferred over the external bus 60.

Additionally, the command format 290 includes a command delay and type field 285. This includes information which can be used by the interface 120 to determine how many cycles must lapse before it can issue a next command. For data transfer commands it includes burst length and burst type information to be output over the control bus of the external bus 60 to format the external data transfers taking place over the external bus.

The interface 120 will then use the information provided in the command format 290 in order to output appropriate signals from the interface pins onto the control bus of the external bus 60 to cause the external memory 55 to perform the required steps, for example opening a row, closing a row, accessing data, etc. Given that the information to be passed onto the control bus includes burst length and burst type information, more pins may need to be provided at this interface. Alternatively, the command will be output over more than one cycle, in order to avoid an increase in pin count.

Considering now the paths provided within the memory controller 35 corresponding to the write data channel and the read data channel of the interconnect logic 45, it will be seen that the memory controller 35 provides a write data FIFO 130 for the write data being received on the write data channel, and also provides a read data FIFO 140 for the data being received from the data channel of the external bus 60 for routing on to the read data channel of the interconnect logic 45. Since the data channel of the external bus will typically be a bi-directional bus, the logic element 150 is provided which is controlled by a signal output by the memory controller 35, typically by the interface logic 120, to control whether write data in the write data FIFO 130 is output on to the data channel of the external bus 60, or whether instead data being received over the external bus is routed to the read data FIFO 140.

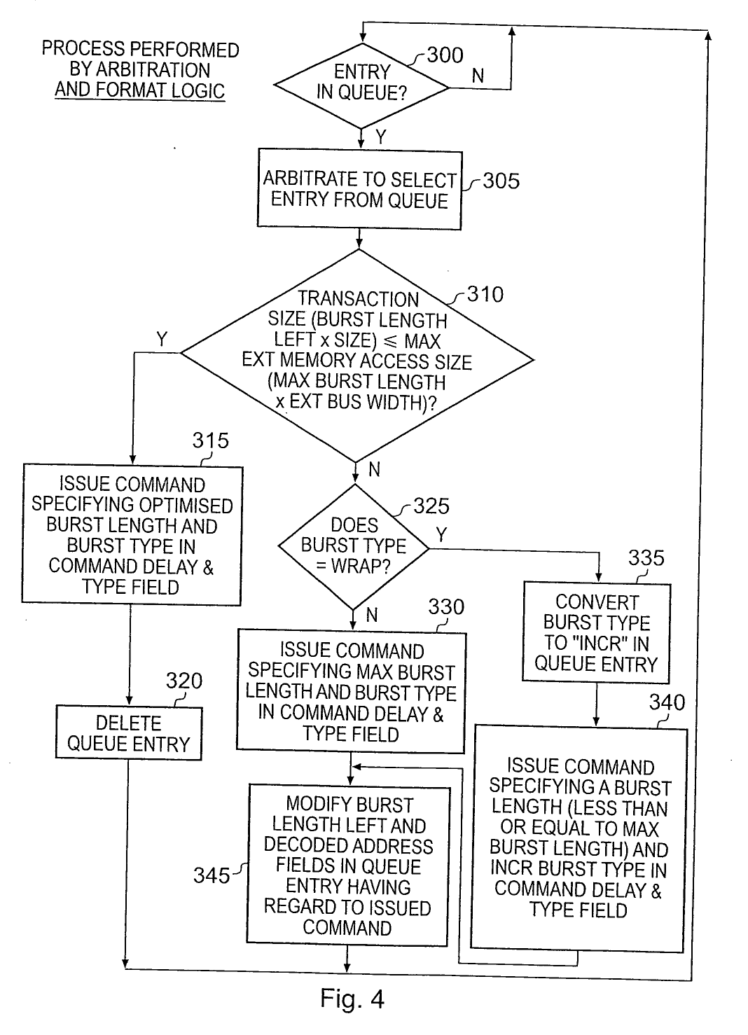

FIG. 4 is a flow diagram illustrating in more detail the steps performed by the arbitration and format logic 115 of FIG. 2 when generating a data transfer command. At step 300, it is determined whether there is an outstanding entry on the queue 110, and if so, then arbitration is performed at step 305 to select one of the entries from the queue. Thereafter, at step 310 it is determined whether the transaction size is less than or equal to the maximum external memory access size. The transaction size is given by multiplying the burst length left information in field 245 by the size information in field 240 of the address transfer format 255. The maximum external memory access size is determined based on a knowledge of the maximum external memory burst length and the bus width (also referred to herein as the external bus data size) of the external memory 60, which are predetermined constraints of the external memory.

If the transaction size is less than or equal to the maximum external memory access size, then the process branches to step 315, where the arbitration and format logic 115 is able to select an external format which can be optimised to ensure that the least number of external data transfers are used to transfer the required data. In particular, the arbitration and format logic 115 can in that instance issue a command specifying an optimised burst length and retaining the same burst type as specified by the transaction occurring over the interconnect logic internal to the integrated circuit. Hence, as an example, if the size of each data transfer over the interconnect logic is the same as the external bus width, and if the transaction over the interconnect logic is a wrap transaction of four bursts, then the command issued by the arbitration and format logic can specify a burst length of four and a burst type of wrap within the command delay and type field 285 of the command 290. By way of another example, if the internal data transfer size over the interconnect logic is twice the size of the external bus width, then again (assuming the transaction size is still less than or equal to the maximum external memory access size) the burst length and burst type can be mapped across from the internal transaction format into the external format, but in this case the burst length of the external format will need to be twice that of the internal transaction format.

Once the command has been issued at step 315, then the associated queue entry within the queue 110 is deleted at step 320, whereafter the process returns to step 300.

If the transaction size is greater than the maximum external memory access size, then it will not be possible to use a single data transfer command to process the transaction. Instead, the process proceeds to step 325, where it is determined whether the burst type specified in the transaction occurring over the interconnect logic is a wrap burst type. If it is not, then the process proceeds to step 330, where the arbitration and format logic 115 issues a command specifying the maximum burst length allowed by the external memory and retaining the burst type of the transaction, again this burst length and burst type information being contained within the command delay and type field 285. Thereafter, at step 345, the burst length left field 245 and the decoded address field 235 of the address transfer 255 in the relevant queue entry is modified having regard to the issued command. This will typically involve modifying the column identifier in the decoded address field 235 and decrementing the burst length left having regard to the amount of data to be accessed by the command issued at step 330. Thereafter, the process returns to step 300. By returning to step 300 at this point, this enables the arbitration performed at step 305 to be performed between each data transfer command and hence it will not necessarily be the case that the next command issued will relate to the same transaction.

It at step 335 it is determined that the burst type is a wrap burst type, then the process proceeds to step 335. Since the transaction size exceeded the maximum external memory access size, then it will not be possible to replicate the wrap burst type on the external bus, and instead at step 335 the relevant queue entry is modified to change the burst type to increment burst type. Thereafter, at step 340, the arbitration and format logic 115 issues a command specifying a burst length which will be less than or equal to the maximum burst length allowed by the external memory, as well as specifying an increment burst type. Again, this information is contained within the command delay and type field 285. Ideally, at step 340, the command will wish to specify a burst length that is equal to the maximum burst length, but it may be that this is not always possible. For example, if the initial transaction issued by the master was a wrap transaction having a burst length of eight, and starting with a data value six (as indicated by the start address in the start address field 205), then the actual sequence of data values required is as follows: 6, 7, 0, 1, 2, 3, 4, 5. The command issued at step 340 will initially have to specify a burst length of two, even if the maximum burst length of the external memory is greater than two, since in this first access it will only be possible to access data values 6 and 7.

After step 340, the process proceeds to step 345, where the burst length left 245 and decoded address 235 fields in the relevant queue entry are modified having regard to the issued command. Then the process returns to step 300.

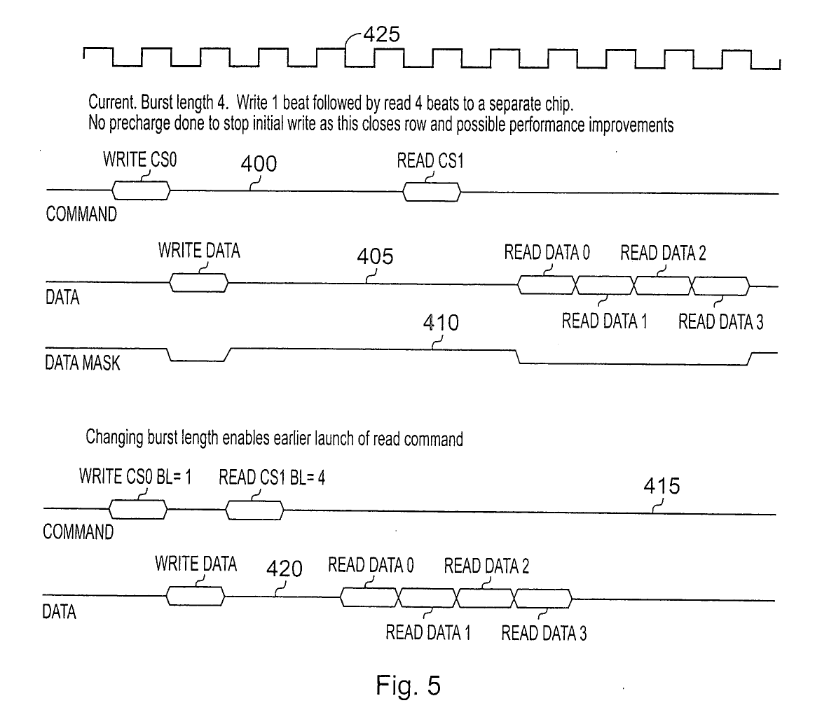

FIG. 5 is a timing diagram illustrating a particular example transaction, and contrasting how external memory would be accessed for that transaction in accordance with a known technique and in accordance with a technique of one embodiment of the present invention. In particular, in this example, it is assumed that a write transaction of one beat is followed by a read transaction of four beats to a separate chip. Signal line 425 shows a clock signal, and the signal lines 400, 405 and 410 illustrate how the accesses to the external memory would take place in accordance with a known technique where the external memory device operated in a fixed mode of operation with a fixed burst length of four. The first write command is issued over signal line 400, and in the following cycle the first write data value is provided to the external memory over signal line 405. In addition, a data mask line 410 is provided which is set low to allow the data on the data line 405 to be read by the external memory 55.

The write transaction can be interrupted by issuing another write transaction, or by performing a precharge operation to close the row. However, in this instance, the next transaction is not another write transaction, and in addition it is not generally considered appropriate to perform a precharge operation straight away as this will close the row, and avoid any possible performance improvements that could be achieved by keeping the row open. Instead, the subsequent read command is delayed by four cycles given the fixed burst length of four operating on the external bus. Hence, even though no useful write data is being transferred after the first write data value, the external memory is still treating the write access as a write access having a burst length of four, and accordingly cannot begin processing the read command until the four cycles have elapsed. As shown in FIG. 5, once the subsequent read command has been issued specifying chip one, then this will be followed in due course by the four beats of the read data.

In accordance with the embodiments of the present invention, the external burst length is selectable by the arbitration and format logic 115. In particular, for the write transaction, it will be determined at step 310 of FIG. 4 that the transaction size is less than the maximum external memory access size, and in that event at step 315 a command can be issued on line 415 specifying an optimised burst length of one. The write data is output on line 420 in a subsequent cycle, but then in the immediately following cycle the next read command can be issued on line 415, given the earlier specified burst length of one. As a result, the four beats of the read data appear on the data line 420 much earlier than they would do in accordance with the known technique where the external burst length was fixed (as is immediately apparent from a comparison of line 420 with line 405 in FIG. 5).

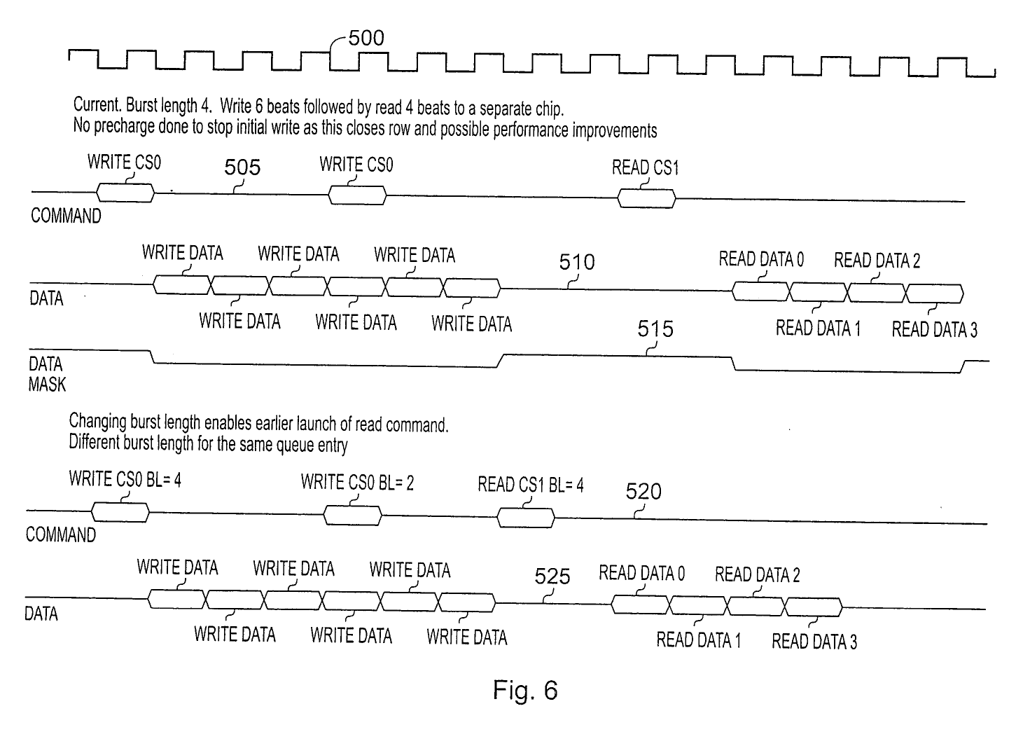

FIG. 6 illustrates another example of a transaction where again the known technique employs a fixed external burst length of four, and the transactions occurring in this instance are a write transaction of six beats followed by a read transaction of four beats to a separate chip. In accordance with the known technique, a first write command will be issued on line 505 to cause four beats of the write data to be transferred, and then a second write command will be issued to cause the remaining two beats to be issued. However, since for the second write command, as with the first write command, the fixed burst length of four is used, then the subsequent read command to chip one cannot take place until four cycles have elapsed after issuance of the second write command. As shown in the upper half of FIG. 6, a data mask signal 515 is used which is set low for the first six write data values on line 510, and then set high to mask the remaining two cycles of the second write command.

As shown the in lower half of FIG. 6, when adopting a technique in accordance with embodiments of the present invention, the first write command can be issued on line 520 specifying the maximum external burst length of four and then the second write command can be issued specifying a burst length of two. With reference to FIG. 4, it will be appreciated from step 345 that after issuing the first write command, the burst length left and decoded address fields in the queue entry will have been modified, such that at the time of considering issuance of the second write command, the format logic 115 will determine at step 310 that the transaction size is now less than the maximum external memory access size, and accordingly at step 315 can issue as the second write command a command specifying a burst length of two. Since the second write command specifies a burst length of two, this enables an earlier launch of the subsequent read command on line 520 than would otherwise have been possible using the known approach. Further, this example illustrates the use of different burst length commands for handling different data transfers pertaining to the same queue entry, i.e. the same transaction.

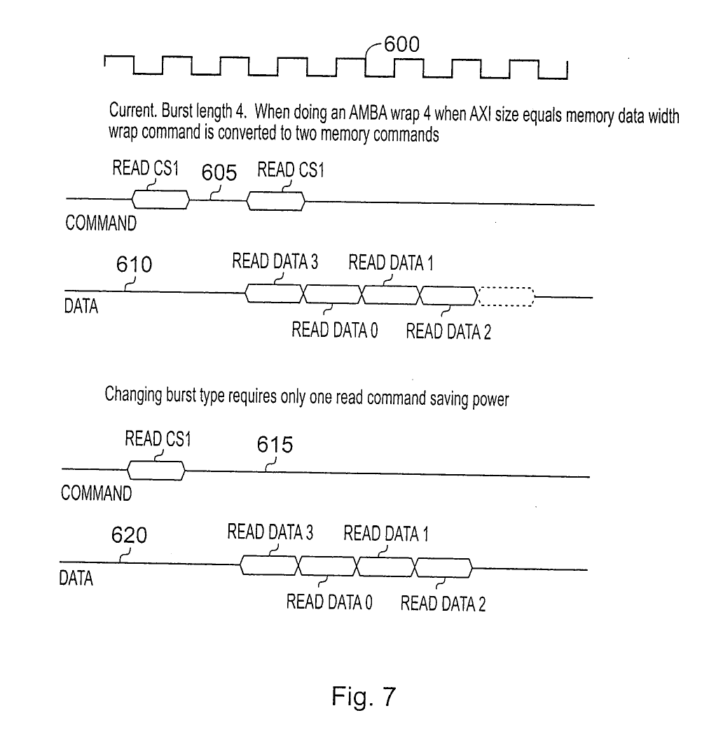

FIG. 7 illustrates a third example where again the known technique is assumed to use a fixed external burst length of four, and in this case the transaction involves a read transaction of four bursts having a wrap burst type. Further, in this example, it is assumed that the size of each data transfer over the interconnect logic equals the size of the external memory bus width. In accordance with the known technique, the external memory would also use a fixed burst type of increment, and accordingly the transaction has to be processed as two separate increment data transfer commands on the external bus. The first read command on line 605 will cause data value three to be read. It is possible to interrupt a read command by another read command, and accordingly in this instance it is not necessary to wait four cycles before issuing the second read command, and instead, the second read command can be issued one cycle after the first read command. The second read command will again have a burst length of four, and will cause data values 0, 1, 2, and 3 to be read. However, the second occurrence of the data value 3 will be ignored by the memory controller (as indicated by the dotted lines on line 610 in FIG. 7.

However, in accordance with the technique of embodiments of the present invention, since at step 310 in FIG. 4 it will be determined that the transaction size is equal to the maximum external memory access size, then again the process can proceed to step 315, where the burst type can be changed to wrap burst type on the external bus, and accordingly a single command can be issued on line 615 specifying a burst length of four and a burst type of wrap. This will cause the required data to be output on line 620. Whilst in this particular example, there is no performance improvement with respect to the known technique, due to the ability to interrupt the first read command of the known technique with the second read command, there is a power saving, since only a single read command needs to be issued via the memory controller 35 to the external memory 55.

From the above description of embodiments of the present invention, it will be appreciated that such embodiments allow the memory controller to select an external format for the one or more external data transfers having regard to the format of the transaction taking place over the interconnect logic and at least one predetermined constraint of the external memory. This provides a particularly efficient technique for using the available resources of the external bus 60.

Although particular embodiments have been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

We claim:

1. An integrated circuit comprising:
interconnect logic operable to couple master logic units and slave logic units to enable transactions to be performed, each transaction comprising an address transfer from a master logic unit to a slave logic unit and one or more data transfers between that master logic unit and that slave logic unit;
at least one master logic unit operable when seeking to access data from an external memory to initiate a transaction by issuing the address transfer via the interconnect logic, the transaction having format information associated therewith used to format the one or more data transfers of the transaction for transfer over the interconnect logic;
a memory controller operable to act as a slave logic unit for the transaction, the memory controller being coupled to the external memory via an external bus and being operable to process the transaction by issuing one or more commands to the external memory over the external bus to cause one or more external data transfers to take place between the memory controller and the external memory;
for each command the memory controller being operable to select an external format for the one or more external data transfers having regard to at least one predetermined constraint of the external memory and the format information of the transaction.

2. A data processing apparatus as claimed in claim 1, wherein the format information comprises at least one of a burst length identifying the number of data transfers to take place over the interconnect logic and a burst type identifying how the address of the data accessed is altered between each data transfer.

3. A data processing apparatus as claimed in claim 2, wherein the format information further comprises an interconnect data size indicating the amount of data in each data transfer over the interconnect logic.

4. A data processing apparatus as claimed in claim 1, wherein the format information is included in the address transfer.

5. A data processing apparatus as claimed in claim 1, wherein the at least one predetermined constraint of the external memory comprises a maximum external memory burst length.

6. A data processing apparatus as claimed in claim 5, wherein the at least one predetermined constraint further comprises an external bus data size indicating the amount of data in each data transfer over the external bus.

7. A data processing apparatus as claimed in claim 1, wherein:
the memory controller is operable to determine from the format information of the transaction a transaction size identifying the total amount of data to be transferred by the transaction, and is further operable to determine from the at least one predetermined constraint a maximum external memory access size identifying the maximum amount of data that can be transferred over the external bus in response to a data transfer command issued by the memory controller to the external memory; and
if the transaction size is less than or equal to the maximum external memory size, the memory controller being operable to issue a data transfer command and to select as the external format specified by the data transfer command a format which employs the least number of external data transfers to access the data specified by the transaction.

8. A data processing apparatus as claimed in claim 7, wherein the at least one predetermined constraint of the external memory comprises a maximum external memory burst length, wherein if the transaction size is greater than the maximum external memory size, the memory controller is operable to issue a data transfer command and to select as the external format specified by the data transfer command a format which employs a number of external data transfers determined by the maximum external memory burst length, the memory controller being operable to subsequently issue one or more further data transfer commands to cause the remainder of the data specified by the transaction to be accessed.

9. A data processing apparatus as claimed in claim 7, wherein the at least one predetermined constraint of the external memory comprises a maximum external memory burst length, wherein if the transaction size is greater than the maximum external memory size, and the format information of the transaction specifies a wrap burst type, the memory controller is operable to issue a data transfer command and to select as the external format specified by the data transfer command a format which employs an increment burst type and a number of external data transfers less than or equal to the maximum external memory burst length, the memory controller being operable to subsequently issue one or more further data transfer commands to cause the remainder of the data specified by the transaction to be accessed.

10. A data processing apparatus as claimed in claim 1, wherein the external memory is dynamic memory consisting of a number of banks of memory.

11. A data processing apparatus as claimed in claim 1, wherein the external memory is static memory.

12. A method of operating an integrated circuit to access external memory, the integrated circuit having interconnect logic operable to couple master logic units and slave logic units to enable transactions to be performed, each transaction comprising an address transfer from a master logic unit to a slave logic unit and one or more data transfers between that master logic unit and that slave logic unit, the method comprising the steps of:
when a master logic unit wishes to access data from the external memory, initiating a transaction by issuing the address transfer via the interconnect logic, the transaction having format information associated therewith used to format the one or more data transfers of the transaction for transfer over the interconnect logic;
causing a memory controller to act as a slave logic unit for the transaction, the memory controller being coupled to the external memory via an external bus and processing the transaction by issuing one or more commands to the external memory over the external bus to cause one or more external data transfers to take place between the memory controller and the external memory;
for each command the memory controller selecting an external format for the one or more external data transfers having regard to at least one predetermined constraint of the external memory and the format information of the transaction.
